(19) United States
(12) Patent Application Publication
(10) Pub. No.: US 2003/0216999 A1
(43) Pub. Date: Nov. 20, 2003

(54) Lock-and-key consumer billing data protection for telemarketing

(75) Inventor: Neil Barry Rothfarb, West Hartford, CT (US)

Correspondence Address: PATTON BOGGS, PO BOX 270930, LOUISVILLE, CO, 80027, US

(73) Assignee: World Class Marketing

(21) Appl. No.: 10/146,252

(22) Filed: May 15, 2002

(51) Int. Cl. G06F 17/60

(52) U.S. Cl. 705/40

(57) ABSTRACT

A “lock-and-key” consumer billing data protection capability is provided to telemarketing systems which are based upon previously-acquired consumer lists. The lists contain partial billing information for each consumer, which is insufficient to access the consumer's account. Thus, at the time a telemarketer employing this capability communicates with a consumer to offer them a product or service, the telemarketer, the telemarketer's client providing the offered product or service, and any entity hired to perform billing operations for such consumer purchases all remain “locked” out from accessing the consumer's account. When the consumer wishes to authorize the purchase of an offered product or service, the consumer must provide the “key” to the consumer's account, which is the missing billing information not acquired from the list provider.

### FIELD OF THE INVENTION

The present invention relates generally to computer systems, and more particularly to computerized order entry systems that support and facilitate telemarketing operations.

### PROBLEM

The practice of companies offering to sell goods or services to consumers directly over the telephone, without requiring the consumer to visit a traditional (“bricks and mortar”) store, is known as telemarketing. In today's business climate, telemarketing has become ubiquitous.

Historically, one of the primary problems with telemarketing was that telemarketers did not precisely target consumers who were likely to buy their products or services. Rather, telemarketers routinely employed “cold calls” in an attempt to reach a broad range of consumers. Recently, however, telemarketers have recognized that consumers and the companies providing the goods and services which they market and sell would all benefit from targeted telemarketing. Accordingly, telemarketers have begun to target their efforts to those consumers who most likely would be receptive to the specific products and/or services being offered. Specifically, a telemarketing company attempting to sell a product or service of one of its clients may acquire from a third-party a list of consumers who recently purchased other products or services. For example, a telemarketing company attempting to sell memberships in a dial-in roadside assistance service program may acquire a recent consumer list from a third-party vendor of car telephones.

When a consumer agrees to purchase a product or service offered by a marketer, in order to access that consumer's account (i.e., bill that consumer), it is necessary to possess certain “billing information.” At a minimum, this billing information includes the entire number, typically sixteen digits, of the consumer's credit card. The same billing information is required regardless of whether the entity accessing the consumer's account is the telemarketer itself, the seller, or any other entity hired to perform the billing operations.

There are two general approaches presently employed to acquire this billing information necessary to access a consumer's account.

The first approach is to acquire all of a consumer's billing information from the list provider that provided the consumer list being used by the telemarketer. Under this approach, a consumer's billing information is often acquired from the list provider before the telemarketing company calls that consumer. Variations on this approach include acquiring a consumer's billing information only after the telemarketing company calls the consumer and verifies that the consumer wants to purchase the offered product or service with the same credit used for the prior purchase (commonly referred to as a “matchback”). Under the variations of this approach, however, all of the consumer's billing information is ultimately acquired from the list provider—and it is this information acquired from the list provider that is used to access the consumer's account.

The advantage of this approach is that it eliminates the need for consumers to recite their credit card number over the telephone. This protects consumers from reciting billing information sufficient to access their account to untrustworthy telephone sales agents employed by legitimate telemarketers and entities that are not legitimate telemarketers.

The disadvantage of this approach, however, is that consumers are not in control of their billing information. As long as a telemarketing company professes to have interpreted some response from a consumer as authorizing a purchase, the consumer's account can be charged. This charge can take place even if the consumer was confused by the telemarketing script and simply said “yes” in response to a question (perhaps thinking it would make an aggressive telemarketer go away), but did not actually intend to purchase the offered product or service. Thus, even if a telemarketer erroneously believes there has been authorization during a particular telephone conversation, the telemarketer is able to bill the consumer easily and without hesitation.

The second approach is to acquire all of a consumer's billing information directly from the consumer. If a consumer wants to accept a telemarketing offer to purchase a product or service, that consumer must then recite their entire credit card number to the sales agent.

The advantage of this approach is that consumers are in control of their billing information. Without a consumer's credit card number, the telemarketer cannot bill consumers in those situations where they erroneously believe there has been authorization.

The disadvantage of this approach, however, is that consumers must recite all of their billing information over the telephone. Consequently, consumers may recite billing information sufficient to access their account to untrustworthy sales agents employed by legitimate telemarketers and/or entities that are not legitimate telemarketers. In addition, this approach produces billing mistakes due to errors in the transmission and communication of the consumers' billing information to the sales agent. Finally, from the telemarketers' perspective, this approach is not desirable because consumers are disinclined or afraid to recite their entire credit card number over the telephone even if they otherwise want to buy the product or service being offered.

Therefore, given the above, what is needed is a lock-and-key consumer billing data protection capability for telemarketing systems that combines some or all of the advantages of the above-described approaches, while eliminating or reducing some or all of their respective disadvantages.

### SOLUTION

The present lock-and-key consumer billing data protection system provides consumer billing account security to telemarketing systems that are based upon consumer lists which may be acquired from a list provider.

The lock-and-key consumer billing data protection system, in one embodiment, includes a marketing database that stores consumer records presently available to the telemarketer or acquired from third-parties from whom such consumers have previously purchased goods or services. Each stored record includes consumer identification information and partial billing information. Because there is only partial billing information (typically fewer than all of the alphanumeric characters needed to access a consumer's account) presently available to the telemarketer or acquired from the list provider, the telemarketer, seller and companies hired to perform billing operations are “locked” out of every consumer's account. Further, a telemarketing server allows the sales agents employed by the telemarketing company and utilizing the telemarketing system to access the consumer identification information stored in the consumer records. The server may bar their access to the partial billing information stored in the consumer record. If a consumer wishes to purchase a product or service being offered, the consumer must provide the “key” to the consumers account, which is the missing billing information not yet stored in the telemarketing database. Only after the consumer supplies the “key,” can the consumer be charged. Specifically, now that all the consumer's billing information has been acquired—partly from the list provider and partly from the consumer—can the consumer's account can be accessed by the telemarketer, seller or an entity hired to perform billing operations for such purchases. The consumer can directly contact the telemarketer to initiate an inbound communication session, or the telemarketer can contact the consumer to initiate an outbound communication session, and both cases can follow the sale of another product or service.

One advantage of the lock-and-key consumer billing data protection system is that consumers are in control of their billing information. Without receiving the missing billing information (the “key”) from the consumer, no entity can bill the consumer based on an erroneous premise that authorization for a particular transaction was received during a telemarketing telephone conversation. Unlike the presently employed approach of acquiring all of a consumer's billing information from a third party, the lock-and-key consumer billing data protection system “locks” companies out of a consumer's account until the consumer takes the proactive step of reciting the missing billing information—the “key ”—to a sales agent over the telephone. This advantage becomes even more important in light of the fact that many sales agents employed by telemarketers receive a substantial amount of their compensation from sales commissions. Lock-and-key consumer billing data protection combats this compensation scheme's incentive to maximize the amount of claimed sales in situations where a consumer's acceptance is ambiguous or even non-existent.

Another advantage of the lock-and-key consumer billing data protection system is that it eliminates the need for consumers to recite their entire credit card number over the telephone to possibly untrustworthy sales agents employed by legitimate telemarketers or to fraudulent persons posing as telemarketers. Although individual sales agents learn part of a consumer's billing information—the “key”—which they enter into the telemarketing system, they are never furnished with the partial billing information already stored in the telemarketing server. As a result, the sales agents also are “locked” out of consumers' accounts.

Further features and advantages of the invention as well as the structure and operation of various embodiments of the lock-and-key consumer billing data protection system for telemarketing are described in detail below with reference to the accompanying drawings.

### BRIEF DESCRIPTION OF THE FIGURES

The features and advantages of the present lock-and-key consumer billing data protection system will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating the architecture of a lock-and-key consumer billing data protection system and an environment in which it is operational; FIG. 2 is a flow chart depicting the operation of a lock-and-key consumer billing data protection system; and

FIG. 3 is a diagram representing an information transfer flow within a lock-and-key consumer billing data protection system.

### DETAILED DESCRIPTION

Overview

The present lock-and-key consumer billing data protection system relates to providing a “lock-and-key” consumer billing data protection capability to telemarketing systems. In an embodiment, a telemarketer selling particular good(s) and/or service(s) acquires a list of consumers (typically from a list provider) or has in its possession a list of consumers. This list identifies consumers who have previously purchased goods and/or services, thus allowing for targeted telemarketing.

Such consumer lists presently available to the telemarketer or transferred to the telemarketer from the list provider contain only partial billing information (p alphanumeric characters of the m+p alphanumeric character consumer billing information) for each consumer. That is, the partial billing information comprises a predetermined subset of data from the consumer's complete billing data, and fails to include the entirety of the billing data. One such example is a string of consecutive digits of the consumer's account number. Because complete billing information is needed to access a consumer's account, the present lock-and-key consumer billing data protection system for electronic marketing “locks” out the marketer, the seller, and even an entity hired to perform billing operations for such purchases from accessing the consumer's account.

When a consumer is called by a sales agent and takes a proactive step to unambiguously order the offered product(s) and/or service(s), the lock-and-key consumer billing data protection system requires that they provide only certain numbers from their credit cards—the “key”—in order to authorize the purchase. This is done without allowing the sales agent access to the consumer's partial billing information previously stored in the telemarketing system. The telemarketer, seller, or company hired to perform billing operations, however, now has all of the consumer's billing information and, as a result, can access that consumers account.

Lock-and-key consumer billing data protection empowers consumers with the ability to buy goods and services over the telephone while controlling access to their account and eliminating the need to recite all of their billing information over the telephone. Thus, lock-and-key consumer billing data protection guards against consumers being billed for products or services whose purchase they did not, nor intend to, authorize by requiring consumers to take the affirmative, proactive step of communicating part of their billing information to authorize a purchase. At the same time, lock-and-key consumer billing data protection guards against untrustworthy sales agents employed by legitimate telemarketers and/or entities that are not legitimate telemarketers by denying access to all of a consumer's billing information.

The present lock-and-key consumer billing data protection system for telemarketing is described in terms of the above example. This is for convenience only and is not intended to limit the application of the present lock-and-key consumer billing data protection system for telemarketing. In fact, after reading the following description, it will be apparent to one skilled in the relevant art(s) how to implement the lock-and-key consumer billing data protection system for telemarketing in alternative embodiments (inbound telemarketing, outbound telemarketing, upsells, etc. etc.).

Glossary

Below are definitions of terms used herein. In the event that a term defined herein has a more common meaning or usage, the definition provided herein should be taken as the intended meaning.

“Billing information” means the minimum data needed in order to charge or otherwise gain access to a consumer's account, such as a credit card, checking, savings, share or similar account, utility bill, mortgage loan account or debit card. In most instances, such minimum information is a set of alphanumeric characters, such as the typical sixteen-digit credit card account number.

“Partial billing information” means some portion (less than all) of the billing information.

“Credit card” means any debit, prepaid, charge, or credit card (whether private label or bank issued), or plate, coupon book or other credit device existing for the purpose of obtaining money, property, labor, or services as authorized by the consumer in whose name the credit card is issued.

“Consumer” means any person who is or may be required to pay for goods, services or a charitable contribution offered or solicited through telemarketing.

“Consumer identification information” means the data used to contact a consumer (eg. name, telephone number, street address, electronic mail address, etc.).

“List Provider” means an entity that provides the telemarketer with a list of consumers for use in their activities. The list typically identifies consumers who recently purchased other products or services and typically includes only partial billing information (p alphanumeric characters of the m+p alphanumeric character consumer billing information) for each consumer, as noted above.

“Seller” means any person who, in connection with a telemarketing transaction, provides, offers to provide, or arranges for others to provide goods or services to the consumer in exchange for consideration. For simplicity of description, the term “telemarketer” is used herein to include the instances where the telemarketer is also the seller, since such a distinction is unnecessary for the purpose of describing the operation of the lock-and-key consumer billing data protection system for electronic marketing.

“Telemarketer” means any person who, in connection with telemarketing, initiates or receives telephone calls to or from a consumer. Further, the terms “user,” “telemarketer,” “telemarketing company,” “entity,” and the plural form of these terms are used interchangeably throughout herein to refer to those who would access, use, and/or benefit from the lock-and-key consumer billing data protection capability provided to telemarketing systems as described herein.

“Telemarketing” means a plan, program or campaign which is conducted to induce the purchase of goods or services or a charitable contribution, by use of one or more telephones.

Lock-and-Key System

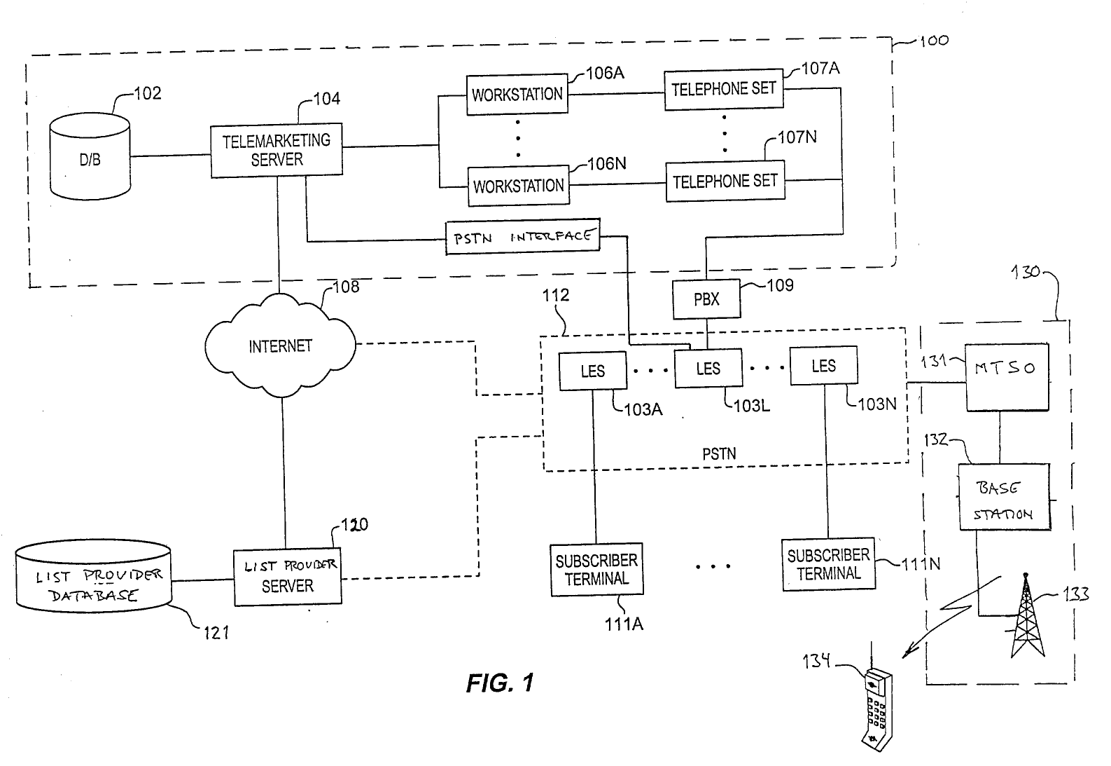

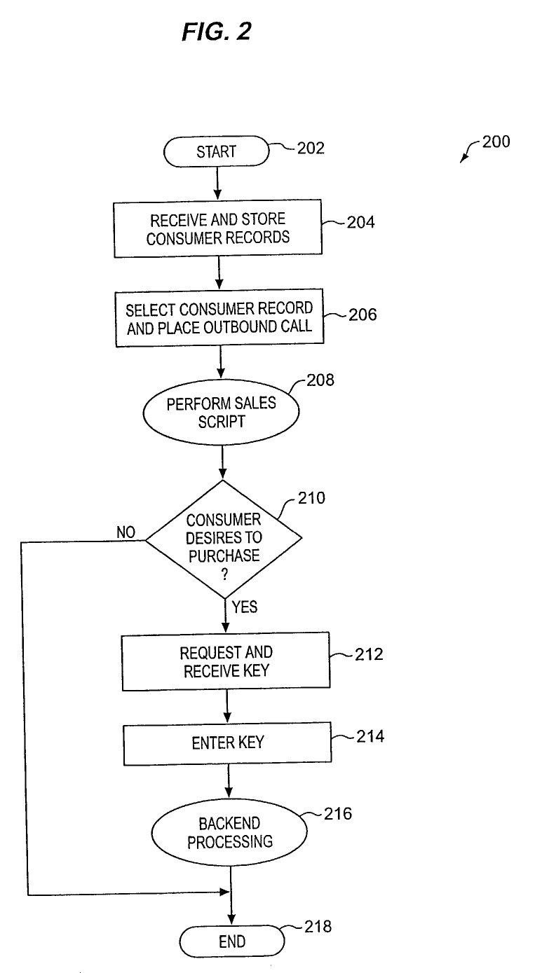

FIG. 1 is a block diagram that illustrates the architecture of a lock-and-key consumer billing data protection system for telemarketing 100, termed “consumer billing data protection system” herein. FIG. 1 highlights the connectivity among the various components of consumer billing data protection system 100.

Consumer billing data protection system 100 includes a repository database 102. Database 102, in an embodiment, is a computer running database management server software with physical media which acts as a central store for information within consumer billing data protection system 100. That is, database 102 stores the consumer lists presently available to the telemarketer or received by the telemarketing entity, including the records containing consumers' identification information, the partial billing information, any key received from a consumer and possibly any collected demographic information.

In an alternate embodiment, database 102 would only store records containing consumers' contact and demographic information. That is, a seller engaging a telemarketer to perform marketing activities on its behalf would retain the partial billing information (except for the name of the credit card) for added consumer protection from possibly untrustworthy telemarketing entities.

Returning to FIG. 1, a telemarketing server 104 is the data processor of consumer billing data protection system 100, and is connected to database 102. Telemarketing server 104 allocates, distributes and provides the data stored in database 102 to a plurality of workstations 106 (shown in FIG. 1 as workstations 106A-106N) used by a plurality of sales agents employed by the telemarketer. In an embodiment, telemarketing server 104 provides workstations 106 with graphical user interface (GUI) “front-end” screens to present certain data in the consumer records (one at a time) during the telemarketing process.

Each of the plurality of sales agents is also equipped with a telephone station set 107 (shown in FIG. 1 as 107A-107N) and the telemarketing server 104 is capable of originating outgoing telephone calls. Assuming for the purpose of the description herein that the sales agents are equipped with telephone station sets 107, a Private Branch eXchange (PBX) 109 functions to interconnect the telephone station sets 107 via trunks with a Local Exchange System (LES) 103L. Local Exchange System 103L is part of the Public Switched Telephone Network (PSTN) 112. This allows the telemarketer to originate calls to (or receive calls from) identified consumers in a well-known fashion.

The consumers are typically equipped with one or more of: a personal computer, hand held computing device, telephone station set or other subscriber communication device, collectively termed “subscriber terminal equipment” 111 herein (and shown in FIG. 1 as 111A-111N). Each consumer's subscriber terminal equipment 111 is generally served by PSTN 112 which consists of an Inter-Exchange Carrier network (IXC) 113 that inter-connects a plurality of Local Exchange Systems 103 (shown in FIG. 1 as LES 103A-103N), each serving a plurality of subscriber terminal equipments 111 under control of an associated call processor. The physical connection that supports this communication connection is typically effected from each consumer's subscriber terminal equipment 111 through one of the Local Exchange Systems 103 of PSTN 112 (as shown in FIG. 1).

Returning to marketing server 104, it may be configured to communicate with one or more satellite and/or terrestrial wireless mobile communications networks 130. As shown in FIG. 1, the wireless mobile communications network 130 consists of a Mobile Telephone Switching Office (MTSO) 131 that serves one or more base stations 132, that transmit and receive wireless communications with mobile phone 134 via antenna 133. Access to wireless mobile communications network 130 is obtained through the Public Switched Telephone Network 112 and allows the marketing server 104 to communicate electronically with consumers using certain portable wireless subscriber terminal equipment 110 (mobile phones, personal data assistants and the like) in the form of text/multi-media messages via various wireless communications protocols.

Telemarketing server 104 also allows consumer billing data protection system 100 to store consumer lists presently available to the telemarketer or to receive the consumer lists from a list provider. That is, a plurality of servers, such as list provider server 120 belonging to list providers may be authorized to access consumer billing data protection system 100 via the public, global Internet 108. (FIG. 1, however, shows only one list provider server 120 for ease of explanation herein.) Such list provider servers would then transfer consumer records to consumer billing data protection system 100 for storage onto database 102 under the control (authorization, scheduling, validation, etc.) of telemarketing server 104. In an alternate embodiment, list provider servers 120 would access consumer billing data protection system 100 via a dial-in line over the Public Switched Telephone Network (PSTN) 112, rather than the global Internet 108, to PSTN Interface 103.

While one database 102 is shown in FIG. 1 for ease of explanation herein, consumer billing data protection system 100 may utilize one or more databases physically located on one or more computers, which may or may not be the same as telemarketing server 104. Further, in an alternate embodiment, database 102 may be mirrored for fault tolerance and telemarketing server 104 may be implemented as on one or more computers in a mirrored or distributed fashion as well.

Lock-and-Key Process

FIG. 2 is a flow chart depicting the operation of the lock-and-key consumer billing data protection system 100. Billing data protection process 200, which illustrates the order-entry functionality, consumer security and other advantages of consumer billing data protection system 100, begins at step 202, with control passing immediately to step 204.

In step 204, a telemarketer has presently available or receives, either directly or indirectly via a seller engaging the telemarketer, data comprising a list of consumers (typically in the form of database records) and their partial billing information, such as from a list provider, which data is stored in the database 102 associated with telemarketing server 104. In an embodiment, such consumers typically would have purchased good(s) and/or service(s) related to those presently being offered by the telemarketer. In an alternate embodiment, the list of consumers may be created or acquired “in-house” by the telemarketer or seller (for example, by a research department or an affiliated entity). In either event, the received consumer list contains only partial billing information (typically, the name of the credit card and a portion of the credit card number) for each consumer. Telemarketing server 104 receives such consumer records from a list provider's server 120 over the Internet 108 or a dial-in line. In alternate embodiments, telemarketing server 104 receives and loads such consumer records from removable storage media. Telemarketing server 104 then stores the list in database 102 and may block access to a portion of the consumer account information by not allowing access to this partial billing information. The method of restricting access to a portion of a data record on a processor is well known and not described in detail herein.

In an alternate embodiment, the received consumer list contains only the name of the credit card and/or expiration date in addition to consumer identification information. That is, a seller engaging the telemarketer to perform telemarketing on its behalf may choose to retain the partial billing information. While this does not allow the telemarketer to perform certain functions (such as billing information verification), it allows the merchant/seller to provide for added consumer protection from possibly untrustworthy telemarketers.

Returning to process 200, in step 206, the telemarketing server 104 identifies a particular consumer to call from the list received in step 204. The identification and assignment of consumers from the list may be done by telemarketing server 104 in several fashions, including: randomly, alphabetically, geographically or the like. During step 206, the sales agent is allowed access to and presented with the consumer's contact information (typically: name, telephone number, address, etc.) and possible demographic information on their workstation 106. Telemarketing server 104, however, assures that the sales agent is effectively “locked” out of the consumer's partial billing (account) information stored within database 102. In step 208, the telemarketing server 104 initiates an outbound telephone call (or connects an inbound telephone call) via Public Switched Telephone Network 112 to a consumer using subscriber terminal equipment 111. Once connected to the consumer, the sales agent typically performs an assigned “sales script,” that is provided by the seller/merchant, once in communication with the consumer.

In step 210, consumer billing data protection system 100 (telemarketing server 104) determines whether the consumer desires to purchase the offered product(s) and/or service(s). This determination is made by receiving an input (keystroke, mouse click, touch screen event or the like) from the sales agent made on their workstation 106. If the determination of step 210 is negative, billing data protection process 200 then ends as indicated by step 218. Billing data protection process 200 may then be repeated for the next consumer from the received list assigned to that particular sales agent. Otherwise, if the determination of step 210 is positive, the billing data protection process 200 proceeds to step 212.

In step 212, the sales agent requests that the consumer provide (by voice, keypad entries, etc.) the “key”—the missing billing information which the merchant/seller needs in order to access the consumer's account and bill them for the purchased good(s) and/or service(s). In an embodiment of lock-and-key consumer billing data protection, the key is m alphanumeric characters of the m+p alphanumeric character billing information where consumer billing data protection system 100 has previously stored the p alphanumeric characters in step 204 in telemarketing server 104. In an alternate embodiment, the key is the missing m alphanumeric characters of the m+p alphanumeric character credit card billing information in addition to other data unique to the consumer or the consumer's account (such as the ACS code commonly located on credit cards), and this additional information need not be part of the billing information needed to access consumers' account.

In step 214, the sales agent enters the key into consumer billing data protection system 100 using their workstation 106. Thus, the consumer always holds the key to their own account. Only if the consumer proactively locates their credit card and supplies the missing billing information to the sales agent will the merchant/seller have the “key” to access the consumer's locked account.

In step 216, after the missing billing information has been entered into consumer billing data protection system 100 by the sales agent, the telemarketer and/or merchant/seller then performs its normal “back-end” processing to handle, ship —if applicable—and then bill the consumer for the purchased good(s) and/or service(s). The performance of step 216 by consumer billing data protection system 100 (telemarketing server 104) does not involve the telemarketer's sales agents ever having access to consumer's complete billing information on the display provided by telemarketing server 104 to workstation 106. That is, the sales agent receives only the missing information (the key) in step 212. Therefore, lock-and-key consumer billing data protection guards against untrustworthy sales agents employed by legitimate telemarketers and/or fraudulent persons posing as legitimate telemarketers. Billing data protection process 200 then ends as indicated by step 218.

Alternative Telemarketing Scenarios

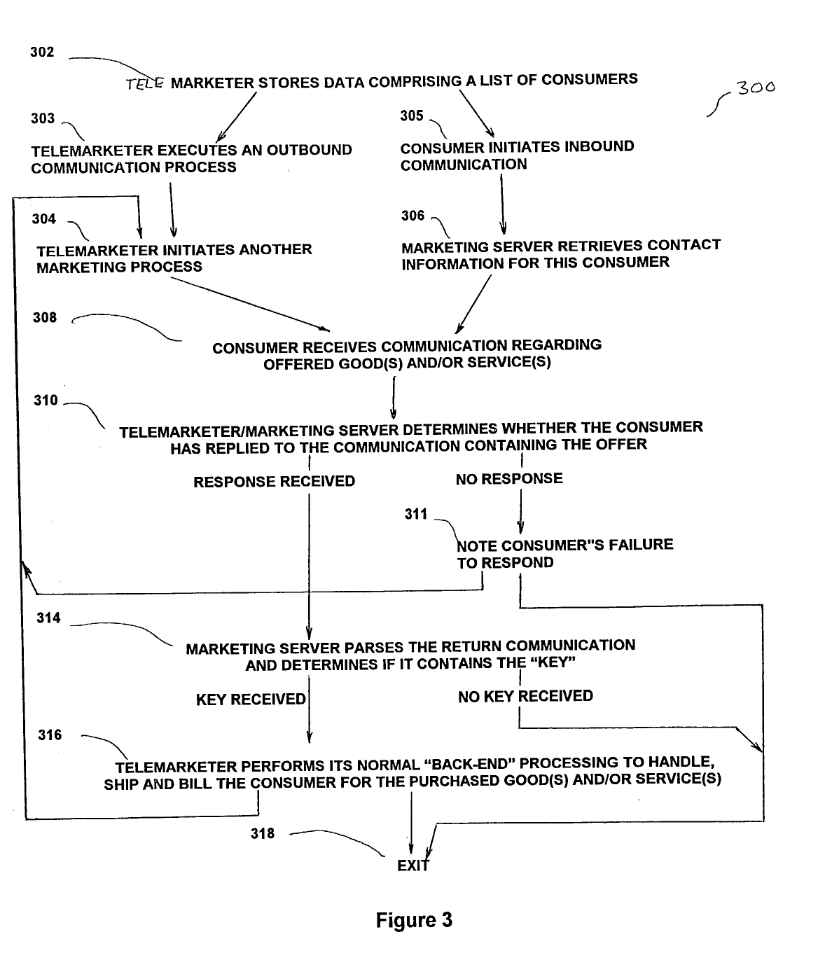

FIG. 3 is a flow chart depicting the operation of a lock-and-key consumer billing data protection system for telemarketing for alternative telemarketing situations. In an alternative sales scenario, the consumer can directly contact the telemarketer to initiate an inbound communication session, typically by contacting the telemarketer via an Interactive Voice Response System 105 or one of the sales agents at the telephone sets 107. Alternatively, the telemarketer can be communicating with a consumer pursuant to an existing telemarketing process, and the telemarketer can initiate a communication session with the consumer regarding another product or service while the initial communication session is still active.

Billing data protection process 300, which illustrates the order-entry functionality, consumer security and other advantages of consumer billing data protection system 100, begins at step 302, where a telemarketer has presently available or receives, either directly or indirectly via a seller engaging the telemarketer, data comprising a list of consumers (in the form of database records) such as from a list provider, which data is stored in the database 102 associated with telemarketing server 104.

There are several ways in which the consumer billing data protection system 100 can be in communication with a particular consumer. The telemarketing server 104 initiates an outbound communication process at step 303, which outbound process is described above with respect to FIG. 2. Upon the conclusion of this outbound process or during this process, the sales agent using the consumer billing data protection system 100 can initiate another telemarketing process at step 304 by retrieving sales information, that identifies another product or service that is offered by the telemarketer, for transmission to the consumer who is presently in communication with the consumer billing data protection system 100. Alternatively, the consumer can initiate an inbound communication to the consumer billing data protection system 100 at step 305. In this instance, the telemarketing server 104 must identify this consumer from the list received in step 302. The consumer is identified by telemarketing server 104 via consumer identification information (e.g. caller identification, etc.) received pursuant to the inbound communication, or via communication with the consumer. Once the consumer is identified, the telemarketing server 104 retrieves the contact information for this consumer from database 102 at step 306.

In step 308, the sales agent uses the consumer identification information to communicate with the consumer regarding the good(s) or service(s) that are offered by the telemarketer. Alternatively, an automated system executing, for example, on telemarketing server 104 creates an outbound communication to the consumer, in response to their inquiry, that is appropriate for the communication medium presently in use to interconnect the consumer with the consumer billing data protection system 100. In the case where the subscriber is using portable wireless terminal equipment 110, such as a mobile phone 112, personal data assistant and the like, in a data message mode, the outbound communication is a message (electronic mail, instant message, multi-media message, or the like) sent to a consumer via wireless mobile communications network 130. The communication contains the sales message and requests that the consumer reply with the “key”—the missing billing information—if they desire to purchase the offered product(s) and/or service(s). In the case where the consumer has telephoned an Interactive Voice Response System 105, the outbound communication can be a recorded audio message and/or a series of audio prompts pursuant to a menu.

In step 310, consumer billing data protection system 100 (telemarketing server 104) determines whether the consumer has replied to the communication. If the determination of step 310 is negative, billing data protection process 300 notes the failure of consumer to reply in database 102 at step 311. Processing then terminates for this consumer at step 318. An additional option at step 31 1, is to initiate another marketing process at step 304, as described above.

Otherwise, if the determination of step 310 is positive this indicates that the consumer transmitted a return communication (instant message, wireless text/multimedia message or the like) or conveyed an acceptance to the sales agent, or provided a tone signal response to the Interactive Voice Response System 105. The return communication containing the key is the consumer's acceptance of the sales message's offer contained in the initial communication. Billing data protection process 300 proceeds to step 314 where the sales agent inputs to the telemarketing server 104 the “key”—the missing billing information which the seller needs in order to access the consumer's account and bill them for the purchased good(s) and/or service(s). In the other communication modes, the key is excerpted from the consumer's response and identified as the missing billing information. In an embodiment of lock-and-key consumer billing data protection, the key is m alphanumeric characters of the m+p alphanumeric character billing information where consumer billing data protection system 100 has previously stored the p alphanumeric characters in step 302 in telemarketing server 104. In an alternate embodiment, the key is the missing m alphanumeric characters of the m+p alphanumeric character credit card billing information in addition to other data unique to the consumer or the consumer's account (such as the ACS code commonly located on credit cards), and this additional information need not be part of the billing information needed to access consumers' account. The communication containing the key is the consumer's acceptance of the sales message's offer contained in the initial communication. Billing data protection process 300 then proceeds to step 316 where the telemarketer and/or seller then performs its normal “back-end” processing to handle, ship—if applicable—and then bill the consumer for the purchased good(s) and/or service(s). Billing data protection process 300 then ends as indicated by step 318. An additional option at step 316 (or at step 314), is to initiate another marketing process at step 304, as described above.

Further Alternatives

While a number of embodiments of the present lock-and-key consumer billing data protection system for telemarketing have been described above, it is also possible for the system to operate with the consumer's billing information being assembled at the entity that performs the consumer billing via the use of two separate data paths. In this instance, the telemarketer has partial billing information that comprises some information that can be used to identify the credit card used by the consumer in order for the telemarketer to communicate with the consumer. The key, obtained from the consumer by the telemarketer, is then forwarded to the billing entity, typically along with the partial billing information that enables the billing entity to identify which of the customer's credit cards is being used. The list provider forwards the remainder of the consumer's billing information to the billing entity, where the two partial sets of billing information are assembled to produce the billing information that is used to bill the consumer for the purchased good(s) and/or service(s). In this manner, the p alphanumeric characters of the m+p alphanumeric character billing information can be transmitted directly to the entity that performs the customer billing, while the telemarketer only deals with the remaining m alphanumeric character billing information (the key).

Another alternative is where the telemarketer first receives the key from the consumer, then activates the telemarketing server to retrieve the partial billing information from the database for use by the billing entity. This process disseminates the partial billing information only when needed to complete a transaction.

Conclusion

While various embodiments of the present lock-and-key consumer billing data protection system have been described above, it should be understood that they have been presented by way of example, and not limitation. It will be apparent to persons skilled in the relevant art(s) that various changes in form and detail can be made therein without departing from the spirit and scope of the invention. Thus, the present lock-and-key consumer billing data protection system should not be limited by any of the above-described exemplary embodiments, but should be defined only in accordance with the following claims and their equivalents.

What is claimed

1. A method for providing a consumer billing data protection capability in a telemarketing system that stores a plurality of consumer records, each of which includes consumer identification information and partial billing information, comprising the steps of:
enabling a sales agent, utilizing the telemarketing system, to access said consumer identification information stored in said plurality of consumer records;
receiving an input indicative that a consumer corresponding to said consumer identification information, stored in one of said plurality of consumer records, desires to purchase a product or service offered by said sales agent, said input including a key received from said consumer, wherein said key completes said partial billing information stored in said one of said plurality of consumer records; and
processing an order for said product or service and billing for said order using the partial billing information stored in said one of the plurality of consumer records, and said key.

2. The method of claim 1, wherein the partial billing information stored in each of the plurality of consumer records is a predetermined set of p alphanumeric characters of the billing information of said consumer.

3. The method of claim 2,, wherein said key is the remaining m alphanumeric characters of the billing information of said consumer, and wherein m+p is equal to the total number of alphanumeric characters in the billing information of said consumer.

4. The method of claim 1 wherein said key includes the ACS code of a credit card.

5. The method of claim 1 further comprising:
retrieving said consumer identification information stored in one of the plurality of consumer records; and
originating a communication connection to said consumer whose consumer identification information is stored in said one of said plurality of consumer records.

6. A method for providing a consumer billing data protection capability in a telemarketing system, comprising the steps of:
storing a plurality of consumer records, each of which includes consumer identification information and partial billing information;
enabling a sales agent, utilizing the telemarketing system, to access said consumer identification information stored in said plurality of consumer records;
receiving an input indicative that a consumer corresponding to said consumer identification information, stored in said one of said plurality of consumer records, desires to purchase a product or service offered by said sales agent, said input including a key received from said consumer, wherein said key completes said partial billing information stored in said one of said plurality of consumer records; and
processing an order for said product or service and billing for said order using said partial billing information stored in said one of said plurality of consumer records, and said key.

7. The method of claim 6 further comprising:
receiving data, comprising said plurality of consumer records, transmitted by a list provider.

8. The method of claim 6, wherein the partial billing information stored in each of the plurality of consumer records is a predetermined set of p alphanumeric characters of the billing information of said consumer.

9. The method of claim 8, wherein said key is the remaining m alphanumeric characters of the billing information of said consumer, and wherein m+p is equal to the total number of alphanumeric characters in the billing information of said consumer.

10. The method of claim 6 wherein said key includes the ACS code of a credit card.

11. The method of claim 6 further comprising:
retrieving said consumer identification information stored in one of the plurality of consumer records; and
originating a communication connection to said consumer whose consumer identification information is stored in said one of said plurality of consumer records.

12. The method of claim 6 further comprising:
receiving an inquiry from a consumer; and
retrieving consumer identification information stored in one of the plurality of consumer records corresponding to the identity of said inquiry transmitting consumer.

13. A method for providing a consumer billing data protection capability in a telemarketing system that stores a plurality of consumer records, each of which includes consumer identification information and partial billing information, comprising the steps of:
receiving a key from a consumer, indicative that said consumer, corresponding to the consumer identification information stored in one of the plurality of consumer records, desires to purchase an offered product or service, and wherein said key completes the partial billing information stored in said one of the plurality of consumer records; and
processing an order for said product or service and billing for said order using the partial billing information stored in said one of the plurality of consumer records, and said key.

14. The method of claim 13, further comprising the step of:
enabling a sales agent utilizing the telemarketing system to access the consumer identification information stored in said one of the plurality of consumer records.

15. The method of claim 13, wherein the partial billing information stored in each of the plurality of consumer records is a predetermined set of p alphanumeric characters of the billing information of said consumer.

16. The method of claim 15, wherein said key is the remaining m alphanumeric characters of the billing information of said consumer, and wherein m+p is equal to the total number of alphanumeric characters in the billing information of said consumer.

17. The method of claim 13, wherein said key includes the ACS code of a credit card.

18. The method of claim 13 further comprising:
retrieving said consumer identification information stored in one of the plurality of consumer records; and
originating a communication connection to said consumer whose consumer identification information is stored in said one of said plurality of consumer records.

19. The method of claim 13 further comprising:
receiving an inquiry from said consumer; and
retrieving consumer identification information stored in one of the plurality of consumer records corresponding to the identity of said inquiry transmitting consumer.

20. A system for providing a consumer billing data protection capability in a telemarketing system that stores a plurality of consumer records, each of which includes consumer identification information and partial billing information, comprising:
means for initiating a communication to a consumer corresponding to the consumer identification information stored in one of the plurality of consumer records;
means for receiving an input, indicative that a consumer corresponding to said consumer identification information, stored in said one of said plurality of consumer records, desires to purchase a product or service offered in said communication, said input including a key received from said consumer, wherein said key completes said partial billing information stored in said one of said plurality of consumer records; and
means for processing an order for said product or service and billing for said order using the partial billing information stored in said one of the plurality of consumer records, and said key.

21. The system of claim 20, further comprising:
means for enabling a sales agent utilizing the telemarketing system to access the consumer identification information stored in said one of the plurality of consumer records.

22. The system of claim 20, wherein the partial billing information stored in each of the plurality of consumer records is a predetermined set of p alphanumeric characters of the billing information of said consumer.

23. The system of claim 22, wherein said key is the remaining m alphanumeric characters of the billing information of said consumer, and wherein m+p is equal to the total number of alphanumeric characters in the billing information of said consumer.

24. The system of claim 20 wherein said key includes the ACS code of a credit card.

25. The system of claim 20 further comprising:
means for receiving data, comprising said plurality of consumer records, transmitted by a list provider.

26. The system of claim 20 further comprising:
means for retrieving said consumer identification information stored in one of the plurality of consumer records; and
means for originating a communication connection to said consumer whose consumer identification information is stored in said one of said plurality of consumer records.

27. A system for providing a consumer billing data protection capability in a telemarketing system, comprising:
storage means for storing a plurality of consumer records, each of which includes consumer identification information and partial billing information;
means for enabling a telemarketer to access said consumer identification information stored in one of said plurality of consumer records;
means for enabling said telemarketer to initiate a communication to a consumer corresponding to said consumer identification information stored in said one of said plurality of consumer records;
means for receiving an input from said sales agent, indicative that a consumer corresponding to said consumer identification information, stored in one of said plurality of consumer records, desires to purchase a product or service offered by said sales agent, said input including a key received from said consumer, wherein said key completes said partial billing information stored in said one of said plurality of consumer records; and
means for processing an order reflective of said product or service and billing for said order using said key.

28. The method of claim 27, wherein the partial billing information stored in each of the plurality of consumer records is a predetermined set of p alphanumeric characters of the billing information of said consumer.

29. The method of claim 28, wherein said key is the remaining m alphanumeric characters of the billing information of said consumer, and wherein m+p is equal to the total number of alphanumeric characters in the billing information of said consumer.

30. The system of claim 27 further comprising:
means for retrieving said consumer identification information stored in one of the plurality of consumer records; and
means for originating a communication connection to said consumer whose consumer identification information is stored in said one of said plurality of consumer records.

31. A system for providing a consumer billing data protection capability in a telemarketing system that stores a plurality of consumer records, each of which includes consumer identification information and partial billing information, comprising:
means for receiving an input, indicative that a consumer corresponding to said consumer identification information, stored in said one of said plurality of consumer records, desires to purchase a product or service offered in said communication, said input including a key received from said consumer, wherein said key completes said partial billing information stored in said one of said plurality of consumer records; and
means for processing an order for said product or service and billing for said order using the partial billing information stored in said one of the plurality of consumer records, and said key.

32. The system of claim 31, further comprising:
means for enabling a sales agent utilizing the telemarketing system to access the consumer identification information stored in said one of the plurality of consumer records.

33. The system of claim 31, wherein the partial billing information stored in each of the plurality of consumer records is a predetermined set of p alphanumeric characters of the billing information of said consumer.

34. The system of claim 33, wherein said key is the remaining m alphanumeric characters of the billing information of said consumer, and wherein m+p is equal to the total number of alphanumeric characters in the billing information of said consumer.

35. The system of claim 31 wherein said key includes the ACS code of a credit card.

36. The system of claim 31 further comprising:
means for receiving data, comprising said plurality of consumer records, transmitted by a list provider.

37. The system of claim 31 further comprising:
means for retrieving said consumer identification information stored in one of the plurality of consumer records; and
means for originating a communication connection to said consumer whose consumer identification information is stored in said one of said plurality of consumer records.
